(19) United States
(12) Patent Application Publication
(10) Pub. No.: US 2006/0129661 A1
(43) Pub. Date: Jun. 15, 2006

(54) Controlling execution of files transmitted to clients

(76) Inventor: Katsuhisa Kataoka, Sagamihara-shi (JP)

Correspondence Address: IBM CORPORATION, 3039 CORNWALLIS RD., DEPT. T81 / B503, PO BOX 12195, REASEARCH TRIANGLE PARK, NC, 27709, US

(21) Appl. No.: 11/291,129

(22) Filed: Nov. 30, 2005

(30) Foreign Application Priority Data
Dec. 13, 2004 (JP) 2004-360628

(51) Int. Cl. G06F 15/177; G06F 15/16

(52) U.S. Cl. 709/220; 709/217

(57) ABSTRACT

To control the execution of files transmitted by servers to clients, such as application program updates, suitable for application to a network system that includes a communication network connected to a server and a plurality of clients. The server transmits a file executable in the clients and an execution start date data indicating an execution start date for the executable file to the clients. The clients determine whether to execute the executable file based on the current time and the execution start date data.

### FIELD OF THE INVENTION

The present invention relates to a method of updating data for clients and controlling execution of the updated data by the use of a network system.

### BACKGROUND

Hitherto, an application program executable by a client has been distributed to all of the clients connected to a network from a server. Updates of the application program (update data) have also been distributed from the server to all the clients, over the network.

The clients may be geographically disbursed. For example, a transport and administration system may have a few servers and a multiplicity of clients provided for branch offices across the country.

Such clients separate the application program (which will hereinafter be referred to as “static data”) from data for use in the application program (hereinafter referred to as “dynamic data”). Usually, only one client at a time is permitted to communicate dynamic data with the server. Such data has a relatively small file size. Consequently, the volume of data flow is not adversely affected on the communication network.

Nevertheless, the data flow associated with the updating operation might overload the communication network when updating the application program, because the file size is large, and the update of the application program is repeated as many times as there are clients.

Further, when the application program of the plurality of clients in the system is updated and executed, it is desirable that all the clients in the system begin executing the newly updated application program simultaneously. For example, when there is a change in the application program that adds items that the clients input, a change accompanied by the addition of the input items occurs to the database of the server as well. In that case, a certain client might transmit dynamic data to the server in the old data format without the new input items, while the other clients transmit the dynamic data to the server in the new data format that includes the new input items. If so, the server needs to process data in both the old and the new data formats.

Since processing both types of data increases the load on the server, it is best to avoid the need to do so. Therefore, a method is desirable which enables the use of the update data in such a way that all of the clients in the system may execute the use of the updated application program simultaneously, at a predetermined time.

A method is known in which the server provides contents while permitting the clients to access the server subject to a time restriction condition, wherein the clients may acquire the contents from the server only at a predetermined time. Such a method is described in Japanese Laid-Open Patent Publication No. 2002-108718, to Kokai.

According to the method of Kokai, in a system including a delivery scheduling apparatus and clients connected to the delivery scheduling apparatus via a communication line, the delivery scheduling apparatus controls contents to be provided with a publication start time and a publication end time to restrict the period of time during which clients can access the contents. Due to the time restriction, the clients can get and use the contents from the server substantially at the same time.

However, a plurality of clients may attempt to access the contents provided by the server all at once, substantially at the same time. This increases the load on the communication line, and therefore restricts the clients' capabilities to acquire the contents, thereby effectively working against the desired goal of simultaneity.

### SUMMARY

One aspect of the invention includes a method applied to a network system that has a server, a plurality of clients, and a communication network connected to the server and the plurality of clients, wherein the server transmits a file executable in the clients via the communication network, the server transmits execution start date data indicating an execution start date of the file to the clients via the communication network, and the clients determine whether to execute the file on the basis of the current time and the execution start date data.

Accordingly, the server transmits the executable file to clients via the communication network, the server transmits the execution start date data indicating the execution start date of the file to the clients via the communication network, and the clients determine whether to execute the file on the basis of the current time and the execution start data.

### BRIEF DESCRIPTION OF THE DRAWINGS

An exemplary embodiment of the present invention is described hereinbelow, with reference to the accompanying drawings, wherein:

FIG. 1 is a block diagram illustrating a configuration of a network system according to an embodiment of the present invention;

FIG. 2 is a flowchart illustrating operational aspects of the network system according to an embodiment of the present invention;

FIG. 3 is a diagram illustrating an exemplary display image of a client;

FIG. 4 is a diagram illustrating another example of the display image of the client;

FIG. 5 is a flowchart showing operational aspects of a server according to an embodiment of the present invention; and

FIG. 6 is a flowchart showing operational aspects of a client.

### DETAILED DESCRIPTION

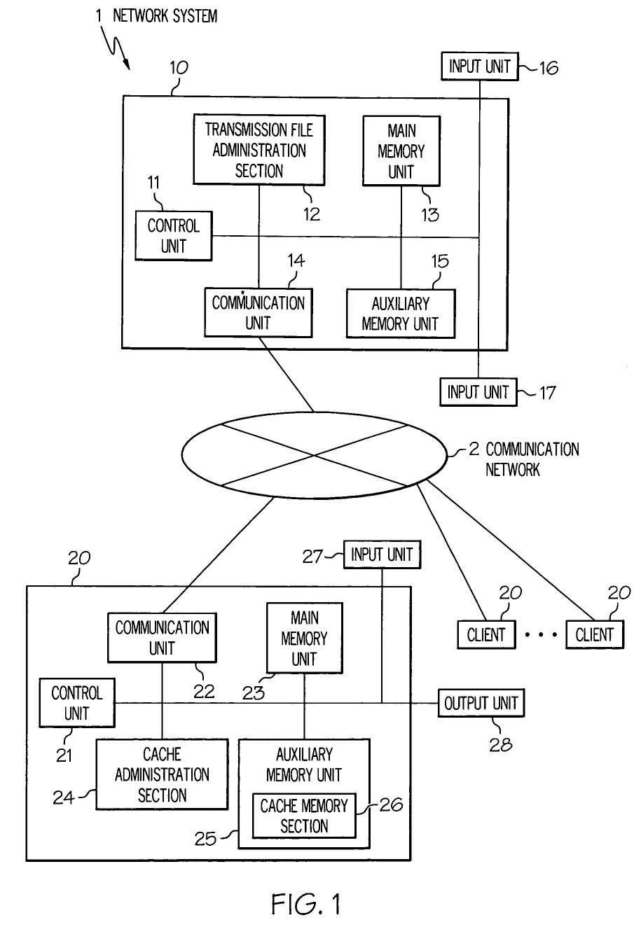

FIG. 1 is a block diagram which illustrates a schematic configuration of a system including a server and clients, according to an embodiment of the present invention. A network system 1 includes an intra-enterprise communication network 2, a server 10, and clients 20 operated by users in, for example, a workplace. The server 10 and the clients 20 transmit data via the communication network 2.

The network system 1 may include a plurality of servers 10 and a plurality of clients 20. The communication network 2 of the network system 1 may be a private or leased line connecting the server 10 and the client 20, or may be a public communication network line such as the Internet.

One purpose of the server 10 is to transmit an application program to one or more clients 20. The updated application program is stored in the server 10 and transmitted to all the clients 20 connected to the network system 1. The server 10 is provided with a control unit 11, a main memory unit 13, a communication unit 14, an auxiliary memory unit 15, an input unit 16, an output unit 17, and a transmission file administration unit 12.

The control unit 11 may include, for example, a CPU (Central Processing Unit) that executes processing and controls the flow of the program and data, such as the CPU of a computer. The main memory unit 13 stores the program or the data, as well as processing results returned by the CPU. The communication unit 14 exchanges the data or parameters between the server 10 and the clients 20, and receives the results therefrom.

The auxiliary memory unit 15 stores data which is accessed less frequently by the control unit 11 or data input via the input unit 16. The auxiliary memory unit 15 may be a floppy disk, a hard disk, a DVD-ROM, or a CD-ROM.

The input unit 16 is connected to the server 10 so as to be used, by the user, to manipulate the computer for providing thereto various kinds of information from outside the computer. The input unit 16 may be a keyboard, a mouse, or a scanner. The output unit 17 displays or prints processing conditions or results, or reproduces them as audio signals. The output unit 17 may be a display, a printer, or a speaker.

The transmission file administration section 12 is provided with a program for executing file management and administration of the application program (static data) of client software (such as a rich client as described below) used in the client 20. The transmission file administration section 12 manages static data required for updating the rich client, and the execution start date on which execution of the static data can begin. Accordingly, the transmission file administration unit 12 determines the static data executable currently and transmits the static data to the clients 20 on the basis of the determination. Therefore, the transmission file administration section 12 is provided with such transmission determination means. Additionally, the transmission file administration section 12 creates a header that includes the execution start date data, as well as the static data to be transmitted.

The transmission file administration section 12 may transmit information on the current date and time at the server 10 to the clients 20 if it determines that the new static data to be transmitted to the clients is not stored in the server 10.

The transmission file administration section 12 may store the static data to be updated in different directories of the auxiliary memory unit 15 according to the execution start date. The static data currently used may also be stored.

The transmission file administration section 12, however, is not required to be an independent unit in terms of hardware, and may be comprised of the control unit 11, the main memory unit 13, and the auxiliary memory unit 15.

The client 20, which may include a computer capable of executing the application program transmitted from the server, receives the update data of the application program, and executes the updated program. The client 20 is provided with a control unit 21, a main memory unit 23, a communication unit 22, an auxiliary memory unit 25, an input unit 27, an output unit 28, and a cache administration section 24.

The control unit 21, the main memory unit 23, the communication unit 22, the input unit 27, and the output unit 28 have functions similar to those of the control unit 11, the main memory unit 13, the communication unit 14, the input unit 16, and the output unit 17, respectively, as described above. Here, the control unit 21 includes execution means configured to execute the application program.

The auxiliary memory unit 25 has a cache memory section 26. The auxiliary memory unit 25 stores the data accessed less frequently by the control unit 21 or the data input via the input unit 27. The auxiliary memory unit 25 may be a floppy disk, a hard disk, a DVD-ROM, or a CD-ROM.

The cache memory section 26 stores a name for identifying the static data, information on the static data being updated (static data update information), information on the execution start date of the static data, and the like. The static data update information may be, for example, a date on which the static data was previously updated (hereinafter, “update date”) or a “file number” as an administration number (a version number) of the file in relation to the static data, as described hereinbelow. The information on the execution start date of the static data may include a storage location of the static data (e.g., a directory or a path of the storage location) or the execution start date (the execution start date data) of the static data.

The cache memory section 26 may be provided in the main memory unit 23 as a main memory instead of the auxiliary memory unit 25 such as the hard disk.

The cache administration section 24 controls the cache memory section 26 provided in the auxiliary memory unit 25. The cache administration section 24 adds a unique header peculiar to the present invention to a request header to be transmitted to the server 10. Additionally, the section 24 includes execution determination means configured to compare the request header added by the transmission file administration section 12 of the server 10 with the update information and the execution start date data of the static data stored in the client 20, to select the static data to be used in the client 20, and to determine whether the selected static data should be executed by the user.

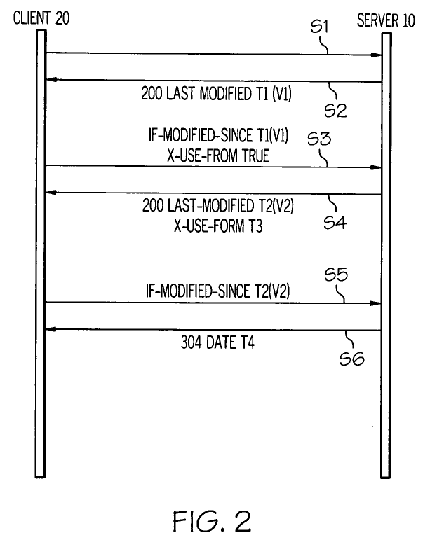

Specific operations of the network system 1 will now be described using FIG. 2. Here, as an example, a situation will be described wherein the static data update information is the “update date.”

The client 20 queries the server 10 about the presence of the updated application program (the static data as the program file executable in the clients) at a predetermined time such as the time when the user starts using the rich client in the client 20 (Step S1). Here, since the new static data was stored in the server 10 at the time T1, the server 10 transmits static data A (T1) of the new update date T1 to the client 20, in response to the reception of the query from the client 20 (Step S2).

The client 20 then queries the server 10 again at the predetermined time (Step S3). At this time, the cache administration section 24 of the client 20 adds an X-Use-From to the request header to query the server 10 as to whether or not the static data A (T1) is still the latest at the current date (Step S3).

If static data A (T2) updated at time T2 is present in the server 10, and if predetermined conditions set in the system are satisfied, the server 10 transmits the request header storing the static data A (T2) together with the execution start date of the static data A (T2), to the client 20, in response to the query from the client 20 (Step S4). The transmission file administration section 12 of the server 10 adds an “X-Use-From-T3” header to the request header (for example, an HTTP header) to transmit the request header to the client 20. More specifically, the added header may include execution start date data indicating that the transmitted application program (the static data) can be executed from the execution start date T3.

At this stage, the transmissions may be executed in the reverse order. Namely, the execution time data of the static data to be transmitted may be transmitted before the actual static data.

Although the two transmissions are simultaneously executed by the server 10 (Step S4) in this example, a discrete packet may be transmitted from the server to the client 20.

The client 20 queries the server 10 again at the predetermined time as to whether or not the static data A (T2) is the latest (Step S5). When the new static data is not stored in the server 10, the server 10 determines that the static data A (T2) is the latest static data. In this case, the server 10 transmits information (304) indicating the absence of the static data to be transmitted and a header storing therein the current date T4 (Date) of the server, to the client 20 (Step S6).

The client 20, upon reception of the header storing the current date T4 of the server 10, compares the current date T4 with the execution start date T3 of the execution start date data. If the current date is past the execution start date, the client 20 replaces the static data A (T1) which is currently used in the client 20 with the static data A (T2) and makes it executable. Additionally, when requested by the user, the client 20 executes the new static data (file). If the current date is not past the execution start date, the static data A (T1) which has been used in the client 20 is used continuously.

For example, in an environment wherein coincidence of time in the client 20 and the server 10 is assured, the client 20 may compare the current time of the client 20 instead of the current time of the server 10 received by the client 20 with the execution start date.

As described above, one client 20 can update the static data and execute the new static data from the execution start date. The server 10 may execute such an updating operation for all the clients connected to the network system 1. Therefore, the server 10 may execute the transmission of the executable file multiple times for each of the clients 20.

When the server 10 executes the transmission multiple times for each of the clients 20, if the server 20 transmits the static data to the last client before the execution start date, the execution of the static data as the executable file is suspended until the execution start date under the condition where the preparation of the static data is completed in all the clients, and the execution of the executable static data is started after the execution start date.

Next, a description will be provided for the case where the static data update information is the “file number” of the static data. The file number may be the version number or a serial number of the static data.

The client 20 queries the server 10 about the presence of the updated static data at a predetermined timing such as the time when the user starts using the application program in the client 20 (Step S1). Here, the new static data having the file number V1 has been stored in the server 10, so that the server 10 transmits the static data A (V1) having the new file number V1 to the client 20, in response to the reception of the query from the client 20 (Step S2).

The client 20 then queries the server 10 again at the predetermined time (Step S3). At this time, the cache administration section 24 of the client 20 adds the X-Use-From to a request header to query the server 10 whether or not the static data A (V1) is the new static data (Step S3).

If updated static data A (V2) is present in the server 10 and if the predetermined conditions set in the system are satisfied, the server 10 transmits the static data A (V2) and the request header storing therein the execution start date of the static data A (V2), to the client 20 in response to the query from the client 20 (Step S4). At this time, the transmission file administration section 12 of the server 10 adds the “X-Use-From T3” header to the request header (for example, the HTTP header) to transmit the request header to the client 20. Namely, the added header is the information indicating that the transmitted static data is executable from the execution start date T3.

The client 20 queries the server 10 again at the predetermined time as to whether or not the static data A (V2) is the latest (Step S5). If the new static data is not stored in the server 10, the server 10 determines that the static data A (V2) is the latest static data. In this case, the server 10 transmits the header storing therein the current date T4 (Date) of the server 10 to the client 20, in response to the query from the client 20 (Step S6).

The client 20, upon reception of the header storing the current date T4 from the server 10, compares the current date T4 with the execution start date data T3. If the current date is past the execution start date, the client 20 replaces the static data A (V1) which is currently used in the client 20 with the static data A (V2). If the current date is not past the execution start date, the static data A (V1) which has been used in the client 20 is used continuously.

The application program transmitted from the server 10 to the client 20 may be a program related to the user interface of the client. Such a program by which the user interface is realized may include a rich client. The rich client may be defined as a function provided in the client 20 for enabling it to browse, modify, or store the server information, and is a program which is executable by the application program transmitted from the server.

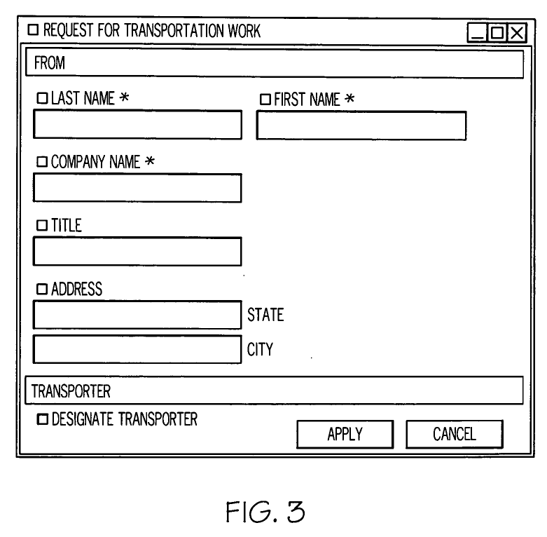

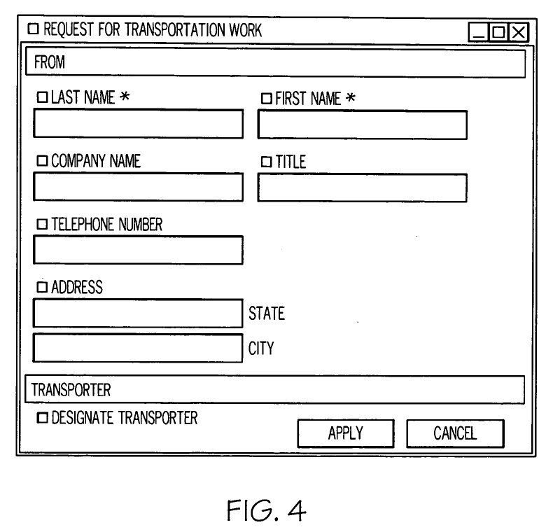

FIGS. 3 and 4 illustrate screen displays of the rich client that have been output to the output unit 28 of the client 20. This rich client provides the service for a “request for transportation work.” That is to say, by executing the request for the transportation work by the client 20 through the rich client, the data (the dynamic data) with regard to the request is transmitted to the server 10 via the communication network 2. Hence, the rich client includes the static data that defines a layout of the screen or the like, and the dynamic data that processes the data displayed on the screen.

The present invention may be applied to an embodiment in which the application program file of a rich client is transmitted from the server 10 to the client 20.

It will now be assumed that a “telephone number” item is added to a window of the request for transportation work as shown in FIG. 3 to modify the overall layout of the window as shown in FIG. 4. In this case, the static data prior to the update will correspond to the application program for displaying the window shown in FIG. 3, while the static data after the update will correspond to the application program for displaying the window shown in FIG. 4. In other words, the afore-described static data A (T1) or A (V1) is the application program for displaying the window shown in FIG. 3, and the static data A (T2) or A (V2) is the application program for displaying the window shown in FIG. 4.

In another embodiment, the client is provided with a web browser. The present invention may be applied in a case where the application program (the static data) for adding the new function to the web browser is transmitted from the server 10 to the client 20. For example, when the server 10 is a web server that communicates using HTTP with a client that has a web browser, the static data file may be transmitted from the cache in the server to the cache in the web browser using an HTTP cache administration header.

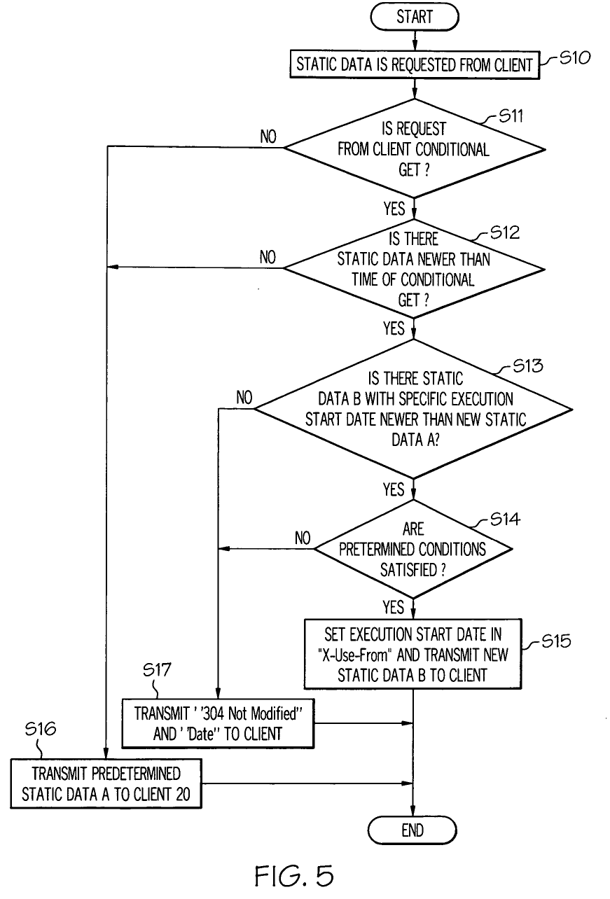

A specific operation of the server 10 will now be described using FIG. 5. First, a request is made to the server 10 for the static data by the cache administration section 24 of the client 20 at the predetermined time (Step S10). In response to the request, the server 10 receives the request. The request for the static data in Step S10 is not limited to the request for the new static data, and it may include the request for the static data when no static data is stored in the cache memory section 26 of the client.

Next, the transmission file administration section 12 of the server 10 determines whether or not the request header includes the “conditional GET” (If-Modified-Since) (Step S11). If the determination is NO, the predetermined static data A is transmitted to the client 20 (Step 16). If the determination is YES, the transmission file administration section 12 compares the time of the conditional GET (the file number of the conditional GET) with the update time of the static data A (the file number of the static data A) to determine whether or not a new static data A is stored in the server 10 (Step S12).

If the determination in Step S12 is YES, the transmission file administration section 12 determines whether or not the static data B, in which the execution start date later than that of the new static data A is specified, is present (Step S13). If the determination is NO, there is no need to update the static data, thereby “Date” as the time information of the server 10 is transmitted to the client 20 (Step S17) in addition to transmitting the “304 Not Modified.”

If the determination in Step S13 is YES, it is further determined whether the server 10 or the communication network 2 satisfies “predetermined conditions.”

The “predetermined conditions” include conditions for the server 10 to transmit the static data, and therefore the conditions may be conditions regarding the processing load on the communication network 2 or conditions regarding whether or not the processing load on the server 10 is high. Further, the predetermined conditions may include the condition as to whether or not the current time is the same as the predetermined time (the period) designated by the user. That is to say, the predetermined condition may concern the time when the network load in the system is to decrease, which may be designated in advance, and the current time.

Here, the conditions to determine whether the utilization rate of the communication network 2 is high may be determined by comparing the size of transmitted files with the communication speed of the communication line. For example, when a file of 24.0 megabits is transmitted on a LAN having a communication speed of 10 megabits/second, the LAN as a whole may be occupied for more than 2 seconds if the LAN uses CSMA/CD (Carrier Sense Multiple Access with Collision Detection) protocol. In this example, the network communication load may be deemed “high” when the communication network 2 is occupied for more than a predetermined time, for example for more than one second.

In addition, the conditions to determine whether or not the processing load on the server 10 is high may be determined by a usage rate of the control unit 11 (e.g., the CPU) of the server 10 (e.g., 50% or higher) or by a usage rate of the main memory unit 13 (e.g., the main memory) of the server 10 (e.g., 50% or higher).

Moreover, while storing in the server 10 the number of times that the static data is subjected to updating by the request of the client 20, as the “predetermined conditions”, the “predetermined conditions” may be determined depending upon whether or not the above-mentioned number of times equals the predetermined number. Additionally, the version of the static data currently operated in the client 20 that requested may be compared with the static data to be transmitted by the server 10. In this case, the “predetermined conditions” may be satisfied when the two versions differ.

If Step S14 is YES, the static data B, the execution start date and the update date of the static data B are transmitted to the client 20. Here, the execution start date of the static data is set in the “X-Use-From” and transmitted to the client 20 (Step S15). The client 20 receives the new static data, the static data update information, and the update date, to update the information stored in the cache memory section 26. If Step S14 is NO, the process proceeds to Step S17.

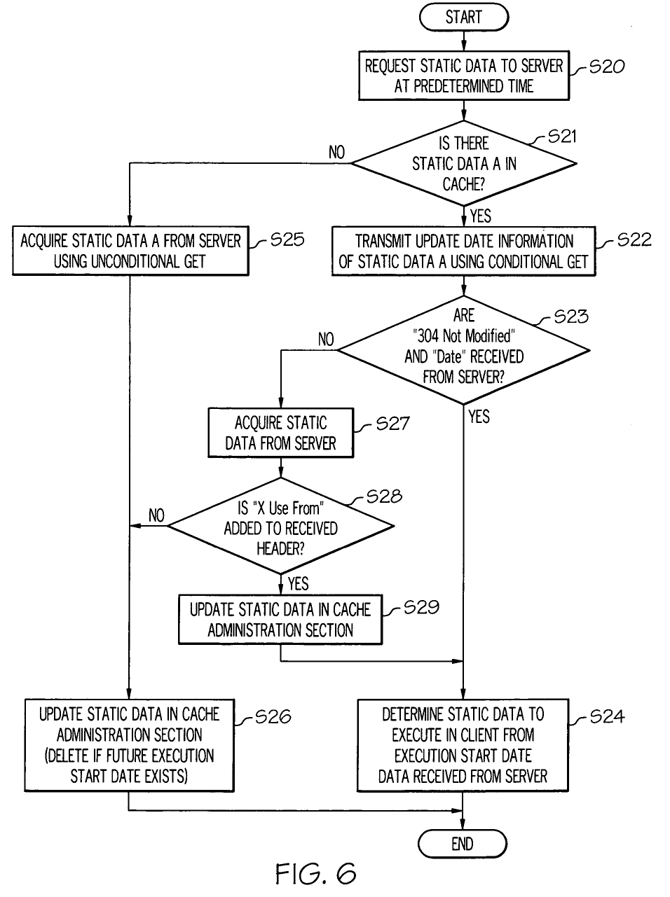

Specific operation of the client 20 will now be described using FIG. 6. The client 20 makes a request to the server 10 for the static data at the predetermined time (Step S20). At this time, it is determined whether or not the static data is present in the cache administration section 24 (Step S21). This determination is made as to whether or not at least one static data including the old version thereof is stored in the cache administration section 24. If the static data is not present in the cache administration section 24, the static data A is acquired from the server 10 using an “unconditional GET” (Step S25).

The “unconditional GET” is defined as a request by the HTTP for requesting the static data without adding the “If-Modified-Since” header to the request header. If no static data is stored in the cache administration section 24, the client 20 requests and acquires, for the present, the static data with no conditions.

After acquiring the static data A, the static data in the client 20 is updated with the static data A (which is made available) (Step S26). Since the execution start date is not specified in this case, the static data is made available immediately after it is acquired.

If Step S21 is YES, the “conditional GET” is transmitted to the server 10 with the update date of the static data A (Step S22). When the “304 Not Modified” and “Date” are received from the server 10 in response, the static data to be used in the client 20 is determined on the basis of the date information (Date) from the server (Step S24). Namely, the client 20 determines to start using the newly-acquired static data if the date information is past the execution start date of the static data, whereas, if not, the client continues to use the current static data.

If Step S23 is NO, the client receives “200 Last-Modified” to thereby acquire the static data from the server 10 (Step S27). In this case, it is determined whether or not the “X-Use-From” is added to the received request header (Step S28). If Step S28 is NO (not added), the static data in the client 20 is updated with the static data A (which is made available) (Step S26). Namely, since the execution start date is not specified in this case, the static data is made available immediately after it is acquired.

If Step S28 is YES (the “X-Use-From” is added), the update date of the static data update information and the static data execution start date are updated based on the updated date information and date of the “X-Use-From” (Step S29). Subsequently, if it is determined that the update date is past the static data execution start date by comparing the update date obtained from the server 10 with the static data execution start date, the client 20 starts using the newly-acquired static data, whereas, if not, the client continues to use the current static data (Step S24).

Although the update date is used as the static data update information in the exemplary embodiment shown in FIGS. 5 and 6, the file number information may be used as the static data update information. That is to say, Steps S12, S22, and S29 may be “the static data A newer than the file number of the conditional GET”, “transmit the conditional GET with the file number of the static data A”, and “update the file number information, the static data, and the execution start date in the cache administration section”, respectively, to determine whether the static data should be updated on the basis of the file number.

The system and method for bringing these embodiments into practice can be accomplished using a program or programs executed in the computer, the client, and/or the server. The program-storage medium (or media) may be an optical memory medium, a tape medium, a semiconductor memory, or the like. The hard disk or the memory unit such as a RAM provided in the server connected to the communication network or the Internet can be used as the storage medium to provide programs via the network.

The present invention is not limited to the described embodiments; rather, many changes and modifications to the invention will now be apparent to one skilled in the art, now having been taught the invention. For example, the present invention may be applied to a web server which is functionally extended by a JAVA servlet, or to the web browser of the client.

What is claimed is:

1. A method applied to a network system comprising a server, a plurality of clients, and a communication network connected to the server and the plurality of clients, said method comprising:
transmitting, by the server to the clients, a file executable in the clients via the communication network;
transmitting, by the server to the clients, execution start date data indicating an execution start date of the file to the clients via the communication network; and
determining, by the clients, whether to execute the file, based on current time and the execution start date data.

2. The method according to claim 1, wherein the server simultaneously executes transmitting the file and transmitting the execution start data.

3. The method according to claim 1, wherein the server and the clients communicate via the communication network using HTTP protocol, and transmitting the execution start data comprises including the execution start date data in an HTTP header.

4. The method according to claim 3, wherein determining whether to execute the file comprises acquiring current time from the HTTP header.

5. The method according to claim 1, wherein determining whether to execute the file comprises determining which file is to be executed when current time is past the execution start date.

6. The method according to claim 1, wherein the file concerns a user interface, and wherein the clients determine whether to execute the file to update the user interface.

7. The method according to claim 1, wherein the clients include a web browser, and the executable file comprises an application program for adding a function to the web browser.

8. The method according to claim 1, further comprising determining whether to transmit the file via the communication network, based on a condition that exists before transmitting the file.

9. The method according to claim 8, wherein the file is transmitted only if the version of the file stored in the server and the version of the file stored in the clients are different.

10. The method according to claim 9, wherein the server and the clients communicate via the communication network using HTTP protocol, and indication that file versions are different is carried by an “If-Modified-Since” HTTP header.

11. The method according to claim 8, wherein the condition concerns processing load on the server.

12. The method according to claim 8, wherein the condition concerns load on the communication network.

13. The method according to claim 8, wherein the condition concerns whether current time has reached a predetermined transmission time.

14. A network system comprising a server, a plurality of clients, and a communication network connected to the server and the clients, wherein:
the server has transmission means for transmitting, from the server to the clients via the communication network, a file executable in the clients and execution start date data indicating an execution start date of the file; and
each of the clients has an execution determining means for determining whether to execute the file based on current time and the execution start date data.

15. The system according to claim 14, wherein the clients comprise execution means for executing the file based on the determination by the execution determination means.

16. The system according to claim 14, wherein the transmission means separately transmits the file as multiple transmissions to the clients.

17. The system according to claim 14, wherein the server has transmission determination means for determining whether to transmit the file based on conditions that exist before transmitting the file.

18. A computer program product for use in a network system comprising a server and a plurality of clients connected to each other via a communication network, the computer program product comprising a computer readable medium having computer readable program code tangibly embedded therein, the computer readable program code comprising:
computer readable program code configured to transmit, by the server to the clients via the communication network, a file executable in the clients;
computer readable program code configured to transmit, by the server to the clients via the communication network, execution start date data indicating an execution start date of the file to the clients; and
computer readable program code configured to determine, by the clients, whether to execute the file, based on current time and the execution start date data.
